(19) United States
(12) Patent Application Publication
(10) Pub. No.: US 2018/0235404 A1
(43) Pub. Date: Aug. 23, 2018

(54) NON-BAKE, TRANSPARENT FOOD MOULD

(71) Applicant: Elham ATOUI, Merrylands, New South Wales (AU)

(72) Inventor: Elham ATOUI, Merrylands, New South Wales (AU)

(21) Appl. No.: 15/548,523

(22) PCT Filed: Feb. 5, 2016
(86) PCT No.: PCT/AU2016/050071

§ 371 Date: Aug. 3, 2017

(30) Foreign Application Priority Data
Feb. 6, 2015 (AU) 2015900383
Apr. 20, 2015 (AU) 2015100527

(51) Int. Cl. A47J 43/20

(52) U.S. Cl. CPC A47J 43/20

(57) ABSTRACT

A plastic, transparent food mould for use in the preparation of non-baked moulded foods, comprising a sleeve having a continuous peripheral wall about opposite openings surrounded by terminal edges of the peripheral wall, and a closure plate for closing a lower one of the openings of the sleeve element and thus defines with the sleeve a mould cavity into which food may be received for setting/moulding, wherein the closure plate has on a first face thereof, which in use closes the lower opening, a rim protrusion extending into the cavity and engaging with a cavity-facing, inner surface of the peripheral wall in a transition fit of such nature as to secure the closure plate in a releasable manner to the sleeve, preferably in sealing engagement, and wherein the closure plate has on a second face thereof a skirt protruding therefrom located radially inward from a peripheral edge of the closure plate.

### TECHNICAL FIELD

The present invention relates to moulds for non-baked foods and more particularly moulds that can be used multiple times primarily in a domestic household (as compared to industrial) food preparation environment. The invention has particular application for use in the preparation of chilled, set or frozen food products, with the mould being re-usable.

### BACKGROUND OF THE INVENTION

In the preparation of food stuffs, moulds are used as a tool to impart shape to food stuffs that can set from a liquid or pasty state into a solid or semi-solid product, such as jellies, pate, mousses, ice creams and cakes. Moulds can also be used in the preparation of multi-layered food stuffs from solid, semi-solid and pasty constituents such as terrines and frozen confections.

Moulds come in a variety of shapes and sizes. In a domestic environment they are generally unitary (one-piece) containers of simple cross-sectional shape such as round, square and rectangular (loaf), typically designed to carry a standard amount of a batter or product. Moulds of course can be also be fancy shapes, e.g. bunt cake moulds, animal shapes, patterned moulds (e.g. fish shapes), and can include surface patterning.

It is also known to use cake oven tins for moulding non-baked food products, such as cheesecakes and the like. Cake tins are typically of a fixed shape and generally manufactured from (coated) sheet metal stamped and drawn into a unitary container comprising a peripheral wall upstanding from a base wall. There are of course other moulds that are manufactured in other materials such as silicone, or in the case of some loaf shapes ceramic materials, even cast iron forms.

One problem associated with the use of the above types of one-piece rigid moulds in setting or assembling food items comprising liquid and/or pasty ingredients arises during de-moulding of the finished moulded food. Whilst setting/freezing can result in the cake or food product contracting, thereby facilitating removal, in particular with cold-set products it is often nonetheless necessary to heat up the mould in a water bath (or otherwise) to promote extraction of the food by thermally softening the interface adhesion zones between food and mould surface, without liquefying it and without loosing the moulded shape of the food. Of course, it is also well known to use lubricating agents to address or prevent the adhesion problem at the mould's inner surfaces. Nonetheless, Success in de-moulding set and/or layered food products is often variable, and dependent to some extent on the skill of the cook.

Spring-form tins have also been used as setting moulds. These include a base and an expandable collar/sleeve to which is attached a spring mechanism. In the open state, the base can be inserted into a lower groove in the expandable sleeve and then secured in place by operating the spring to contract the sleeve to its closed position. Once assembled, a cavity is formed for receiving e.g. a batter or mousse mixture. These two-piece moulds still suffer some of the above mentioned de-moulding problems in particular when no lubricating agents are used.

There are other disadvantages associated with making chilled or set foods in standard cake tins and moulds, but one particular disadvantage is that that the moulds are opaque and only permit the preparation process to be viewed from above. Accordingly, when assembling, for example a multi-layered cake such as a cold cheese cake (having a pastry/biscuit base and potentially multiple toppings), achieving a consistent evenness of all of the layers is very difficult.

An alternative to using a standard cake or springform tin, especially with chilled foods such as mousses and other layer type cakes, is to simply use a glass bowl. However, de-moulding of chilled or set food products from glass bowls is not typically performed.

It is therefore an aim of the present invention to provide an alternative food mould for use in the preparation of non-baked food products that seeks to avoid or ameliorate one or more of the disadvantages identified above and associated with the prior art moulds.

### SUMMARY OF THE INVENTION

In one aspect of the invention there is provided a transparent polymer food mould for use in the preparation of non-baked moulded foods, comprising: a sleeve having a continuous peripheral wall with opposite terminal edges defining opposite openings of the sleeve, and a closure plate for closing a lower one of the openings of the sleeve thereby defining with the sleeve a mould cavity into which food may be received for setting/moulding, wherein the closure plate has a first face, which in use closes the lower opening, with a rim configured to protrude and extend into the cavity and engage with a cavity-facing inner-surface of the peripheral wall in a transition fit of such nature as to secure the closure plate in a releasable manner to the sleeve; and wherein the closure plate has a second face, opposite the first face, with a skirt protruding therefrom, the skirt located radially inward from a peripheral edge of the closure plate.

The inventive mould allows users to easily assemble and disassemble the mould components without the need for other tools, and once assembled, view the layering of the food product(s) poured or placed into the cavity formed between the sleeve and the closure plate base.

Advantageously, the rim at the closure plate and the lower terminal end zone of the sleeve (which ends in the terminal edge) will be dimensioned or be provided with cooperating components which not only ensure a safe transition fit but also provide a liquid seal between the sleeve and the closure plate. This enables the mould to receive liquid food components without leakage past the interface between the sleeve and the closure plate, e.g. when seeking to set watery food products like jellies.

To ensure liquid seal between closure plate and sleeve, one can provide a separate (removable or permanently affixed) sealing element in form of a ring or gasket which locates between the cavity-facing inner surface of the sleeve and the rim of the closure plate or between the terminal (lower) edge about the (lower) opening of the sleeve and the first face of the closure plate. Preferably, such separate sealing element would be made of food grade silicone.

However, in ensuring the liquid seal can be achieved and simultaneously reducing the number of mould constituents, it is preferred to have an integral sealing functionality provided by appropriate geometric dimensioning of the lower opening and surrounding terminal edge of the sleeve and the rim of the closure plate to achieve a liquid tight transition fit between the cooperating components. Noting that the mould components are made from a suitable, food-grade polymer, a certain elasticity and flexibility of the sleeve in particular can be ensured, eg by appropriately dimensioning of its wall thickness, whereby a ‘snap fit’ between the sleeve and the rim component of the closure plate is defined.

In a preferred form, a peripheral terminal end zone of the skirt is shaped and dimensioned to conform with a peripheral terminal end zone about one (or both) of the openings of the sleeve thereby to form a telescopically slidable fit when the sleeve is received within the skirt of the closure plate. This measure enables the mould to be used in an ‘upside-down’ orientation, where the assembled mould—with the terminal end zone of the sleeve comprising one of the openings located within the skirt—can be rested with the rim of the closure plate on a support surface (e.g. a table), as compared with the ‘normal’ orientation where the skirt is intended to provide a pedestal-like base for the ‘normally’ assembled mould and the terminal end zone of the sleeve receives and surrounds the rim of the closure plate.

In a further aspect of the present invention, there is provided a 3-piece food mould comprising a sleeve as defined above and two identical closure plates as defined above, wherein one of the closure plates provides a base carrying and securing the sleeve and the other closure plate provides a lid of the assembled mould. One advantage of having two identical closure plates is that one can assemble a tower of stacked moulds, wherein the lid closure plate of a lower mould provides the base closure plate of the subsequent mould in the tower.

The slidable fit between the skirt of the lid closure plate and the upper end of the sleeve enables the lid to be easily placed on and removed from the other two assembled mould components (base closure plate and sleeve).

Preferably, the sleeve has a cylindrical outer shape, and the peripheral wall of the sleeve will more preferably taper radially inwardly from the lower terminal edge to the upper terminal edge at an angle of between 1 and 5 degrees, preferably about 1.5 degrees, to the vertical. Alternatively, the taper need not be continuous and may indeed comprise a step, as long as the diameter at the lower opening of the sleeve is larger than the diameter at the upper opening of the sleeve (when in upright use orientation). This allows the prepared food product to be easily de-moulded, and also provides for orientation assembly bias, ie the sleeve can only be mounted in one orientation at the base closure plate as explained below.

Whilst the rim could be provided by an annular nose protruding from a uniformly flat plane top surface of the plate, in a preferred form, the closure plate comprises a central, circular plate portion which forms a step with a radially outward located annular flange or edge portion, the step between circular plate portion and annular flange portion providing the rim which extends into and locates within the cavity. That is, the step between the radially inner and radially outer parts of the plate is hereby configured/shaped to provide a mounting arrangement enabling the sleeve to be secured to the closure plate with the transition fit between the sleeve and closure plate. In an even further preferred embodiment, the transition fit between the rim of the closure plate with the cavity-facing inner surface of the sleeve provides the liquid sealing fit.

On the second face of the closure plate, the skirt is provided by a continuous, peripherally running wall that extends approximately vertical from the second face, but preferably with an inclination angle that is the same as that of the sleeve component of the mould near its upper terminal end zone.

In a particularly preferred embodiment, the component parts of the mould are themselves all unitary structures, made from a food grade translucent or fully transparent polymer that is suitable for freezing. Preferably, the polymer is a high impact food grade acrylic, or a polycarbonate, although other suitable transparent food grade plastic materials would be known to those skilled in the art.

While the sleeve is preferably fully transparent, the closure plate of the base and/or lid could be frosted.

The sleeve can be provided with measurement markings to allow sequential filling of the assembled mould with metered amounts of pasty or liquid food components to be moulded and cold-set.

Some of the advantages provided by the mould of the invention include ease of assembly, real-time observation of the food preparation process, and particular the assembly process of a multi-layered food product, ease of de-moulding, and improved storage and transportation of chilled/set food products.

Another advantage of the mould is that the base plate could be used directly as a serving tray, thereby avoiding the need to transfer the prepared food product to another plate or the like after de-moulding has been effected by removing the sleeve from the base closure plate.

Moulds according to the invention and incorporating one or more of the above described optional features can be used for fridge/freezer setting of assembled food products, and their storage. Advantageously, the mould prevents the prepared food product from absorbing extraneous food odours frequently associated with fridges and freezers. It is also particularly useful for transporting an assembled/finished food product for subsequent de-moulding.

Further features and aspects of the present invention will be described below with reference to the accompanying drawings, which illustrate preferred embodiments of the invention.

### BRIEF DESCRIPTION OF THE DRAWINGS

FIG. 1 is a perspective view of an embodiment of the invention, showing a cylindrical mould in assembled state;

FIG. 2 is an exploded view of the mould of FIG. 1, in longitudinal section.

FIG. 3 is a longitudinal section through the mould of FIG. 1 in an assembled state;

FIG. 4 is an enlarged view of detail IV of FIG. 3;

FIG. 5 is an enlarged view of detail V of FIG. 3;

FIG. 6 is a perspective view of an alternate embodiment of a food mould according to the present invention, showing a rectangular format.

### DETAILED DESCRIPTION OF THE EMBODIMENTS

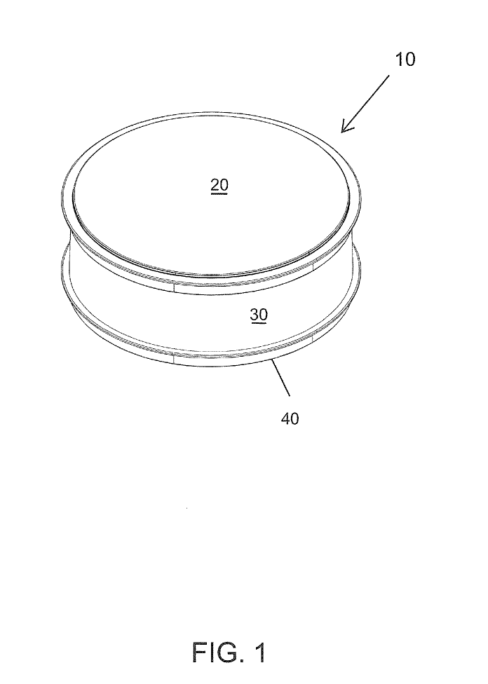

In a preferred embodiment of the invention shown in FIGS. 1 to 5, mould 10 is essentially of round cylindrical exterior configuration and is comprised of three components, a lid 20, a sleeve 30 and a base 40. Each of the components of mould 10 is of unitary construction and made from food grade transparent (clear) acrylic plastic, whereby if desired lid 20 and base 40 could be frosted at least in parts. It is preferred that sleeve 30, which is essentially a squat, hollow, very slightly tapered cylinder, is fully see through (clear), but can be tinted and/or provided with fill-quantity or height metering markings as is know from measuring jugs, for example.

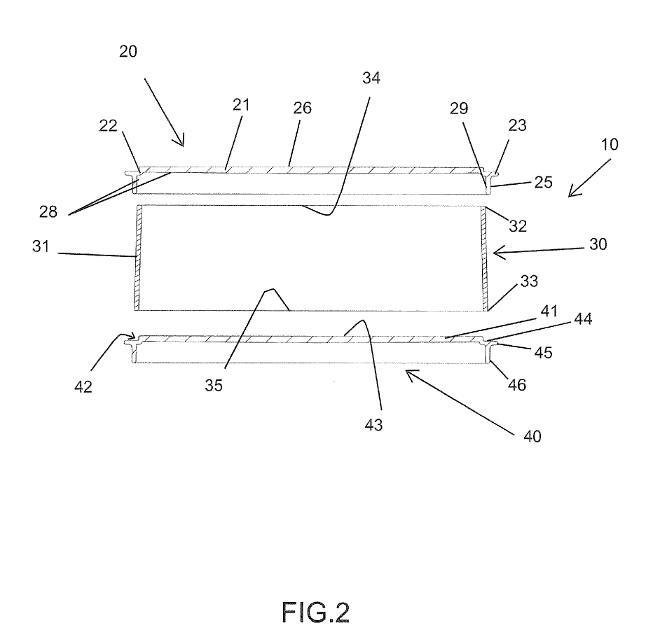

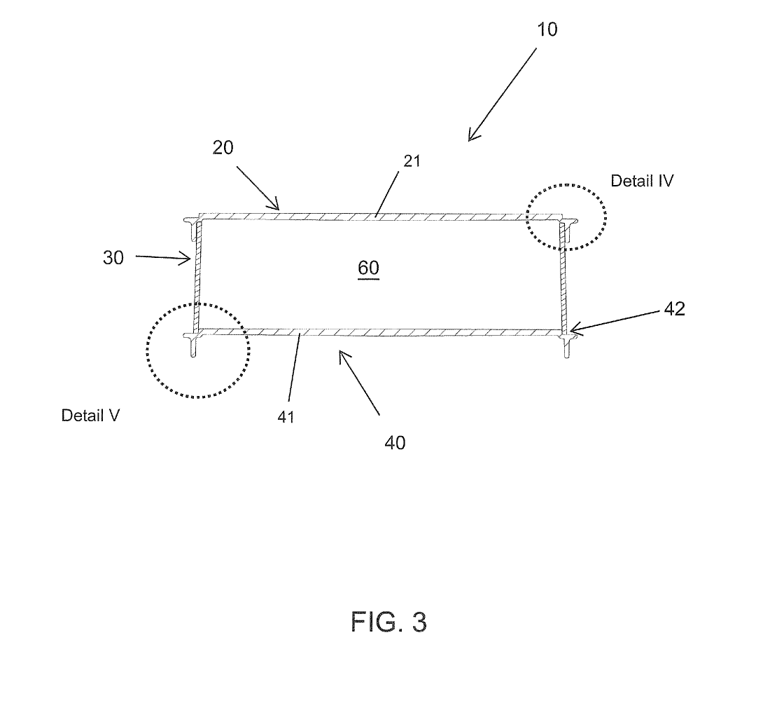

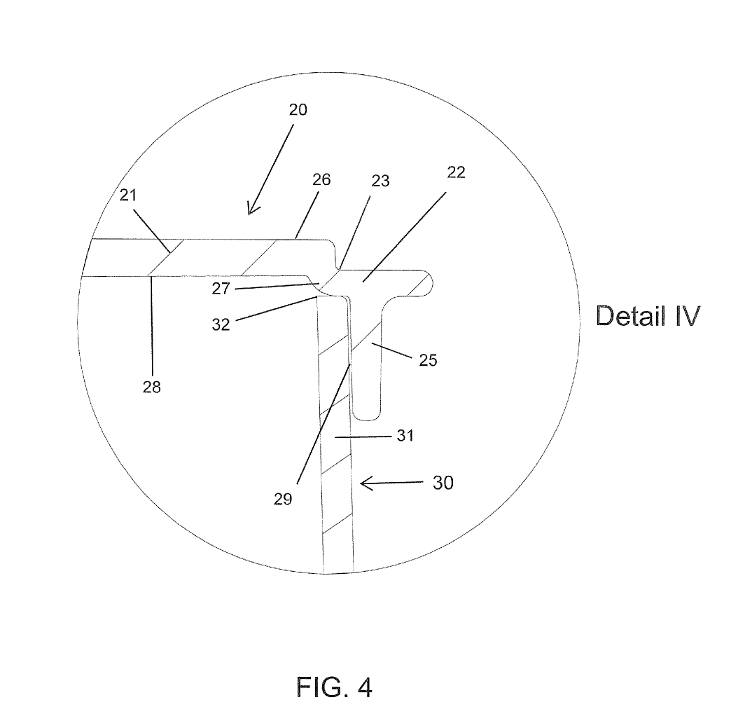

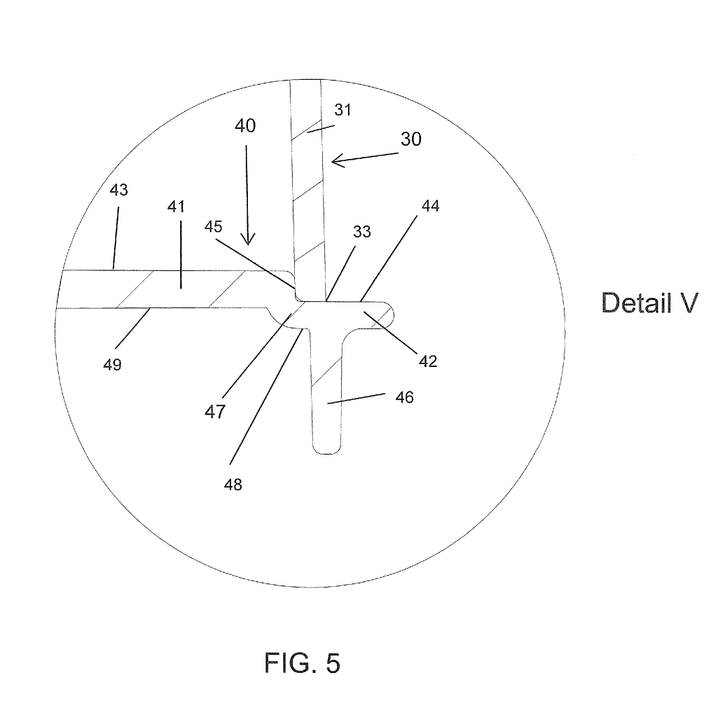

Sleeve 30 (see FIG. 2) has a continuous peripheral wall 31 which extends between opposite upper and lower edges 32, 33 surrounding upper and lower circular openings 34, 35. Sleeve 30 engages with its lower edge 33 onto base 40, as shown in FIGS. 3 and 5, and explained below, to form a cavity 60 in which the food product to be moulded can be received. The food product can be a single food material such as a mouse batter, or provided as multiple food materials to form a layered food product, such as a cheesecake that has a pastry/biscuit base and one or more layers of cheesecake mixture. Upper opening 34 of sleeve 30 is capped by lid 20 to close off cavity 60 as shown in FIGS. 3 and 4, as also explained below.

Turning to FIGS. 2 to 4, lid 20 comprises a central, closure plate portion 21, circular in top plan view, an annular outer flange portion 22 peripherally surrounding closure plate portion 21, and a cylindrical skirt 25 which protrudes downward from about a middle part of outer annular flange portion 22. It will be noted (see FIG. 4) that there is an outer step 23 formed/present between the thin, but otherwise structurally rigid closure plate portion 21 and the adjoining outer annular flange portion 22 such that the upper (or outer) face 26 of plate portion 21 is above the upper face of annular outer flange portion 22.

It will also be noted that another step 27 is located/present between central plate portion 21 and skirt 25 radially inward from skirt 25. Step 27 is formed between the lower inner face 28 of plate portion 21 and the approximately vertically extending, sleeve-facing face 29 of skirt 25. Step 27 provides a supporting ledge for the upper terminal edge 32 of sleeve 30, whereby the inner diameter of lid 20, measured from the inner face 29 of skirt 25, at step 27, and the outer diameter of sleeve 30 at its upper edge 32 are selected/adapted such that a telescopically slidable fit is formed when the upper terminal end zone of sleeve 30 is received within skirt 25 of lid 20.

Turning to FIGS. 2, 3 and 5, base 40 comprises a central closure plate portion 41, circular in top plan view, an annular flange portion 42 peripherally surrounding closure plate portion 41, and a skirt 46 which protrudes downward from about a middle part of annular flange portion 42. It will be noted (see FIG. 5) that a first (outer) step 45 is formed/present between the thin, but otherwise structurally rigid central plate portion 41 and the hereto adjoining annular flange portion 42, such that the upper (or outer) face 43 of plate portion 41 is above the upper face 44 of flange portion 42.

It will also be noted that a further (inner) step 47 is located/present between the central plate portion 41 and annular flange portion 42 radially inward from the cylindrical skirt 46 which extends away from plate 41, such that lip 48 is formed between the lower (or inner) face 49 of plate portion 41 and the inner wall of skirt/rim 46. Annular flange 42 provides a supporting rim for the lower edge 33 of sleeve 30, whereby the diameter of plate portion 41, the geometry of step 45 and the inner diameter of the cavity-forming inner surface at the terminal lower wall portion 31 near edge 33 of sleeve 30 are selected/adapted such that a transition fit is formed when sleeve 30 is received on the rim provided by the step 45 between annular flange 42 and the closure plate portion 41 and which protrudes into the lower end zone of sleeve 30.

The transition fit between sleeve 30 and base 40 is further characterized by being dimensioned to provide an integral liquid-tight seal which prevents leakage of (liquid) food material during the preparation of the food product during a setting stage of one or more of the food products utilized in assembly the food within the mould. and allows the safe storage and transport of the prepared food product thus reducing damage to the prepared food product.

As may be noted from FIGS. 2 and/or 3, upon closer inspection, while sleeve 30 has a generally speaking cylindrical outer shape, the peripheral wall 31 slightly tapers radially inwardly from the lower terminal edge 33 to the upper terminal edge 32 at an angle of between 1.0 and 3.0 degrees, preferably about 1.5 degrees, to the vertical.

This slightly tapped configuration of sleeve 30 allows the prepared food product to be easily de-moulded.

Relevantly, the tapered configuration of the sleeve 30 also provides for ‘orientation assembly bias’ of the mould components sleeve 30 and base 40 (but also for the lid 20), as explained below, despite the base 40 and the lid 20 being otherwise identical in so far as dimensions are concerned, ie the base 40 and lid 20 can be used interchangeably to provide bases or lids.

Due to the slight taper of the peripheral wall 31 of sleeve 30, it can only be mounted in one orientation at the base closure plate 40, noting that the diameter at the lower opening 35 of sleeve 30 is adapted to allow inner closure plate portion 41 to protrude into and be received within sleeve 30, with the lower terminal edge 33 resting on upper surface 44. of annular flange 42, while providing the above mentioned liquid-tight transition fit (at step or rim 45) between abutting parts of sleeve 30 and base plate 40. The slightly smaller diameter of upper opening 34 of sleeve 30 will make it more difficult, if at all possible, to ‘force’ and push the sleeve 30 in an ‘upside-down’ orientation onto the base 40 to secure the components (30, 40) to one another.

The slidable telescopic fit between sleeve 30 and lid 20 allows for ease of assembly of the complete mould for the setting/chilling steps during food preparation, storage and transportation and dis-assembly once a food product is to be de-moulded. When sleeve 30 is removed from base 40, base 40 provides a serving plate, thus avoiding the need to remove the food product from one plate to another.

Equally, because base 40 and lid 20 are identical in configuration, it is possible to stack various moulds, each assembled using a base 40 and a sleeve 30 (without lid 20), one on top of the other, in space saving manner and using less components.

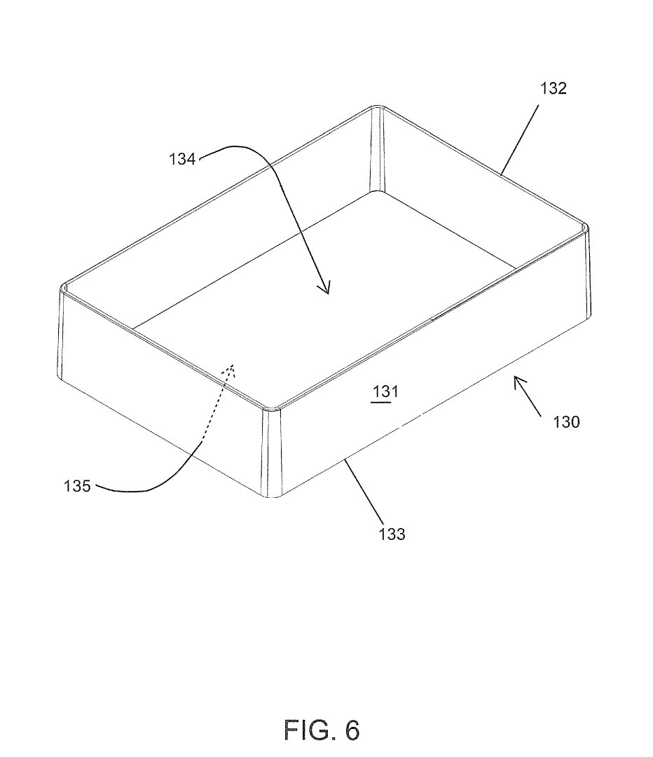

In an alternative embodiment, the mould could have a different cross-sectional shape. FIG. 6 illustrates a sleeve 130 having a rectangular cross-section, with the peripheral wall 131 also having the above mentioned slight taper from lower terminal edge 133 towards upper terminal edge 132 about openings 135 and 134, respectively. The skilled person will then appreciate that the not illustrated lid and base mould components will need to have skirts and central closure plate portions (21 in FIG. 4; 41 in FIG. 5) with similar cross-sectional shapes to provide for complementarily counter-fitting components capable of forming telescopic slidable and transition fits as described above in the preferred embodiment and illustrated in FIGS. 1 to 5, whereas the flange portions (22 in FIGS. 4 and 42 in FIG. 5) could have an entirely different plan footprint, if desired.

The mould, in any shape configuration, is preferably of a standard size used in a domestic or catering kitchen environment, eg a sleeve with an inner diameter of 220, 300, 400 mm, heights between 80 to 200 mm and wall thicknesses of 2.5 to 5 mm, although these values are not to be taken as limiting. The mould can be of such size that is for use in commercial kitchens. The mould could equally be sized to provide individual serving size food items, eg cylindrical, single portion mouses and terrines of 100×100 mm.

As noted, the individual component parts of the mould are formed as unitary components and made of food grade transparent plastic, preferably high impact acrylic. However, other food-grade rigid thermo-setting or thermoplastic polymers which are transparent can be used.

The terms ‘comprising’ and ‘comprises’ are used in this specification in their inclusive meaning of ‘having/has’, ‘including/includes’ and are not to be construed as ‘consisting solely of’

1. A transparent polymer food mould for use in the preparation of non-baked moulded foods, comprising a sleeve having a continuous peripheral wall with opposite terminal edges defining opposite openings of the sleeve, and a closure plate for closing a lower one of the openings of the sleeve thereby defining with the sleeve a mould cavity into which food may be received for setting/moulding, wherein the closure plate has a first face, which in use closes the lower opening, with a rim configured to protrude and extend into the cavity and engage with a cavity-facing inner-surface of the peripheral wall in a transition fit of such nature as to secure the closure plate in a releasable manner to the sleeve; and wherein the closure plate has a second face, opposite the first face, with a skirt protruding therefrom, the skirt located radially inward from a peripheral edge of the closure plate.

2. The food mould of claim 1, wherein the rim at the closure plate and a lower terminal end zone of the sleeve which ends in the terminal edge are complimentarily dimensioned or provided with cooperating components to providing the transition fit.

3. The food mould of claim 2, wherein an integral liquid-tight seal is provided by appropriate geometric dimensioning of the lower opening and the lower terminal end zone of the sleeve and the rim of the closure plate received within the lower terminal end zone of the sleeve.

4. The food mould of claim 3, wherein the peripheral wall of the sleeve has a thickness providing a sufficient degree of elasticity and flexibility at the lower terminal zone of the sleeve to enable a snap fitting of the sleeve to the rim of the closure plate.

5. The food mould of claim 1, wherein a peripheral terminal end zone of the skirt of the closure plate is shaped and dimensioned to conform with a peripheral terminal end zone about one (or both) of the openings of the sleeve thereby to form a telescopically slidable fit when the sleeve is received within the skirt of the closure plate.

6. The food mould of claim 1, further comprising a second closure plate identical to the first closure plate for closing an upper one of the openings of the sleeve, and wherein a peripheral terminal end zone of the skirt of each closure plate is shaped to conform with a peripheral terminal end zone about an upper one of the openings of the sleeve and form a telescopically slidable fit when the upper terminal end zone of the sleeve is received within the skirt.

7. The food mould of claim 1, wherein the continuous peripheral wall of the sleeve tapers radially inwardly from a lower one of the terminal edges to an upper one of the terminal edges of the sleeve wall at an angle of between 1 to 5 degrees, preferably 1.5 degrees.

8. The food mould of claim 1, wherein the closure plate comprises a central, circular plate portion which forms a step with a radially outward located annular flange portion of the closure plate, the step providing the rim which cooperates with the terminal end zone of the sleeve in providing a transition fit mount for the sleeve at closure plate.

9. The food mould of claim 7, wherein the skirt of the closure plate is provided by a continuous, peripherally running wall having an inclination angle that is the same as that of the sleeve near its upper terminal end zone.

10. The food mould of claim 1, wherein the closure plate(s) and the sleeve are integral, unitary structures, made from a food grade translucent or fully transparent polymer that is suitable for freezing.

11. The food mould of claim 1, wherein the polymer is a high impact transparent food grade acrylic.
